(19) United States
(12) Patent Application Publication
(10) Pub. No.: US 2007/0288295 A1
(43) Pub. Date: Dec. 13, 2007

(54) METHOD AND SYSTEM FOR DETERMINING ASSET RELIABILITY

(75) Inventors: Kirk G. O'Brien, Woodstock, GA (US); Robert Nold, Scotia, NY (US)

Correspondence Address: CANTOR COLBURN, LLP, 55 GRIFFIN ROAD SOUTH, BLOOMFIELD, CT, 06002, US

(73) Assignee: GENERAL ELECTRIC COMPANY, Schenectady, NY (US)

(21) Appl. No.: 11/420,022

(22) Filed: May 24, 2006

(51) Int. Cl. G06F 17/30

(52) U.S. Cl. 705/10

(57) ABSTRACT

A method and system for determining asset reliability is provided. The method includes receiving a request to evaluate a component from a requester. The component includes at least a portion of the asset that is operated by the requester. The method also includes acquiring current and historical component-specific data for the component and identifying factors from the current and historical component-specific data. The factors reflect events, the occurrence of which are known to have an effect on asset health. The method further includes determining a component-specific value for the component by applying the factors to a fleet-wide value assigned to a component class to which the component belongs. The method also includes presenting the component-specific value to the requester. The component-specific value is indicative of a potential event with respect to the component.

### BACKGROUND OF THE INVENTION

The present invention relates generally to asset management, and more particularly, to a method and system for determining reliability of assets in a fleet.

Complex equipment typically requires frequent maintenance and servicing. For heavy equipment, such as power generators, this maintenance and servicing often requires on-site visits and inspections to ensure efficient operation and safety. For enterprises that service a large quantity of complex equipment, this can be a challenging task. For example, when faced with numerous service calls or scheduling maintenance or inspections, determining priorities can be difficult. Oftentimes, the service provider obtains preliminary information about the machine from an operator over the telephone in assessing risks for determining the priorities. This may not result in an accurate assessment, as the operator may not be entirely knowledgeable about the equipment. The same may be true when maintenance is performed in-house, that is, by the enterprise operating the equipment.

Tools for evaluating or quantifying risks have been developed that utilize past failure data of many units in predicting failure on a current unit. This solution, however, may not be yield accurate results as each asset has its own unique history and may not follow the trend set by other similar type units.

What is needed, therefore, is a way to efficiently and accurately analyze factors, such as risks associated with an asset in order to establish maintenance priorities with certainty.

### BRIEF DESCRIPTION OF THE INVENTION

A method and system for determining asset reliability is provided. The method includes receiving a request to evaluate a component from a requester. The component includes at least a portion of the asset that is operated by the requester. The method also includes acquiring current and/or historical component-specific data for the component and identifying factors from the current and historical component-specific data. The factors reflect events, the occurrence of which are known to have an effect on asset health. The method further includes determining a component-specific value for the component by applying the factors to a fleet-wide value assigned to a component class to which the component belongs. The method also includes presenting the component-specific value to the requester. The component-specific value is indicative of a potential event or impact for the component.

Other systems, methods, and/or computer program products according to embodiments will be or become apparent to one with skill in the art upon review of the following drawings and detailed description. It is intended that all such additional systems, methods, and/or computer program products be included within this description, be within the scope of the exemplary embodiments, and be protected by the accompanying claims.

### BRIEF DESCRIPTION OF THE DRAWINGS

Referring now to the drawings wherein like elements are numbered alike in the several FIGURES:

FIG. 1 is a block diagram upon which the maintenance evaluation activities may be implemented in exemplary embodiments;

FIG. 2 is a flow diagram describing a process for implementing the maintenance evaluation activities in exemplary embodiments;

FIG. 3 is a flow diagram describing a process for determining fleet-wide values for components and assets used in implementing the maintenance evaluation activities in exemplary embodiments;

FIG. 4 is a sample fleet-wide component history record in exemplary embodiments; and

FIG. 5 is a sample individual component history record in exemplary embodiments.

The detailed description explains the exemplary embodiments, together with advantages and features, by way of example with reference to the drawings.

### DETAILED DESCRIPTION OF THE INVENTION

In accordance with exemplary embodiments, a method and system for determining asset reliability is provided. Asset reliability assessments are facilitated through maintenance evaluation activities described herein. The maintenance evaluation activities calculate a fleet-wide value for issues (e.g., risk values) associated with an asset and its individual components using historical fleet-wide data (e.g., inspection and/or repair history). Current and historical information regarding the asset is obtained and analyzed for factors and these factors are applied to the fleet-wide value (e.g., fleet-wide risk value) in calculating a component-level and/or asset-level value (e.g., component-level and/or asset-level risk values). The component-level or asset-level value reflects the reliability of the asset. The component and asset-level values may be presented in a normalized fashion in order to aid individuals in determining which component/asset requires priority treatment. A relative ranking among assets in a fleet, facilitating planning processes when resources are limited.

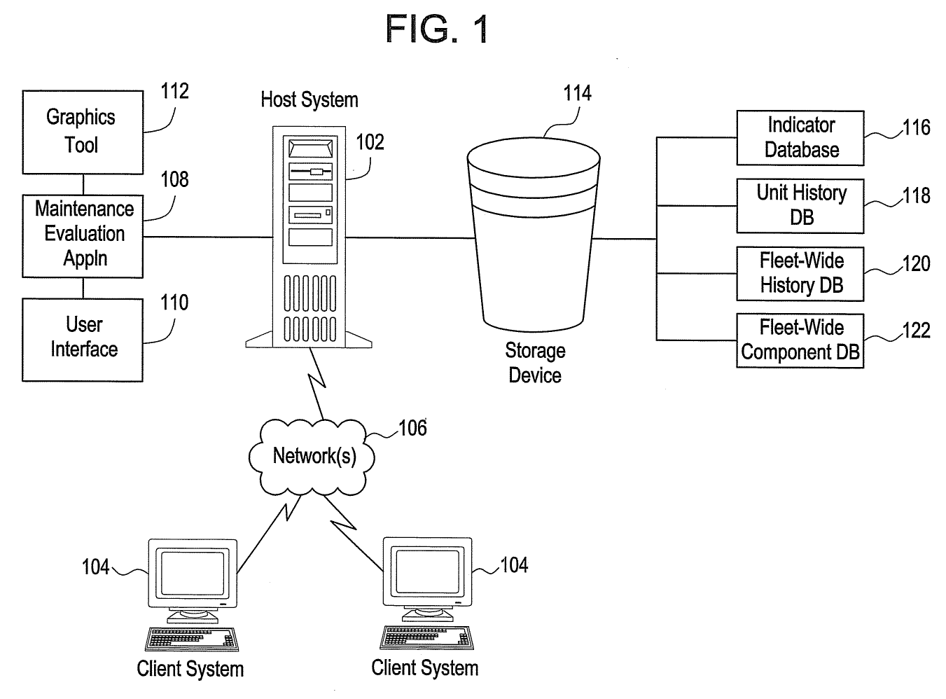

Turning now to FIG. 1, a block diagram of a system upon which the maintenance evaluation activities may be performed in exemplary embodiments will now be described. For purposes of illustration, the maintenance evaluation activities described herein are directed to power generator equipment. However, it will be understood by those skilled in the art that the features described with respect to the maintenance evaluation services may be implemented for any asset (e.g., electrical/mechanical equipment that requires maintenance services).

The system depicted in FIG. 1 includes one or more client systems 104 through which users at one or more geographic locations may contact a host system 102. The host system 102 executes computer instructions for performing asset reliability functions, and the client systems 104 are coupled to the host system 102 via one or more network(s) 106. Client systems 104 refer to customers of the host system 102 that utilize and operate the power generators provided and/or serviced by the enterprise of host system 102.

Each client system 104 may be implemented using a general-purpose computer executing a computer program for carrying out the processes described herein. The client systems 104 may be personal computers (e.g., a lap top, a personal digital assistant) or host attached terminals. If the client systems 104 are personal computers, the processing described herein may be shared by a client system 104 and the host system 102 (e.g., by providing an applet to the client system 104). While only two client systems 104 are shown in the system of FIG. 1, it will be understood that many client systems 104 may be implemented in order to realize the advantages of the maintenance evaluation services.

The host system 102 depicted in FIG. 1 may be implemented using one or more servers operating in response to a computer program stored in a storage medium accessible by the server. The host system 102 may operate as a network server (e.g., a web server) to communicate with the client systems 104. The host system 102 handles sending and receiving information to and from the client systems 104 and can perform associated tasks.

Host system 102 may be implemented by a supplier and/or service provider for power generators. The host system 102 executes one or more computer programs (e.g., the maintenance evaluation application 108) to provide asset reliability assessments. Processing may be shared by the client system 104 and the host system 102 by providing an application (e.g., java applet) to the client system 104. Alternatively, the client system 104 can include a stand-alone software application for performing a portion or all of the processing described herein.

In exemplary embodiments, the maintenance evaluation application 108 includes a user interface 110 for directing users, e.g., individuals at client systems 104 to request and receive assessment information. These individuals are referred to herein as “requesters”. In addition, the maintenance evaluation application 108 may also include a graphics component for presenting the assessment information in graphical form (e.g., charts, graphs, diagrams, etc.).

The network(s) 106 may be any type of known network including, but not limited to, a wide area network (WAN), a local area network (LAN), a global network (e.g. Internet), a virtual private network (VPN), and an intranet. The network(s) 106 may be implemented using a wireless network or any kind of physical network implementation known in the art. A client system 104 may be coupled to the host system 102 through multiple networks (e.g., intranet and Internet) so that not all client systems 104 are coupled to the host system 102 through the same network. One or more of the client systems 104 and the host system 102 may be connected to the network 106 in a wireless fashion. In one embodiment, the network is an intranet and one or more client systems 104 execute a user interface application (e.g. a web browser) to contact the host system 102 through the network 106. In another exemplary embodiment, the client system 104 is connected directly (i.e., not through the network 106) to the host system 102 and the host system 102 is connected directly to or contains a storage device 114.

The storage device 114 may be implemented using memory contained in the host system 102 or it may be a separate physical device. In exemplary embodiments, the storage device 114 is in direct communication with the host system 102 (via, e.g., cabling). However, other network implementations may be utilized. For example, storage device 114 may be logically addressable as a consolidated data source across a distributed environment that includes one or more networks 106. Information stored in the storage device 114 may be retrieved and manipulated via the host system 102 and/or via the client systems 104. In exemplary embodiments, storage device 114 stores an indicator database 116, a unit history database 118, a fleet-wide history database 120, and a fleet-wide component database 122.

Indicator database 116 stores questions for assessing vulnerabilities of components based upon issues, or factors (e.g., risk factors). The term ‘issues’ is used synonymously herein with the term ‘factors.’ Issues, or factors, refer to events or conditions, the occurrence of which are known to have an effect on a component (e.g., a negative or detrimental effect in terms of performance or reliability). Components, in turn, refer to a sub-unit of an asset. For example, a component of a power generator may be a stator. Likewise, a risk factor of the stator may be abrasion or leakage. The questions may be generated by an engineer that is well versed in the mechanics of power generators. The questions are created to address various symptoms having causal connections to the risk factors. Symptoms, e.g., may be defined by specific measurements, such as speed, temperature, pressure, time, etc.

Unit history database 118 stores component and asset information that is specific to a particular asset. For example, if the enterprise of client system 104 operates a power generator serviced by the enterprise of the host system 102, the unit history database 118 stores at least one record that is unique to this power generator. In exemplary embodiments, the record contains a detailed history of information pertaining to the asset including inspection history, detail history, and descriptive information, such as asset age, asset usage, and asset composition. All of this information may be useful in assessing future reliability. A sample record utilized by the maintenance evaluation services for storing this information is shown and described in FIG. 5.

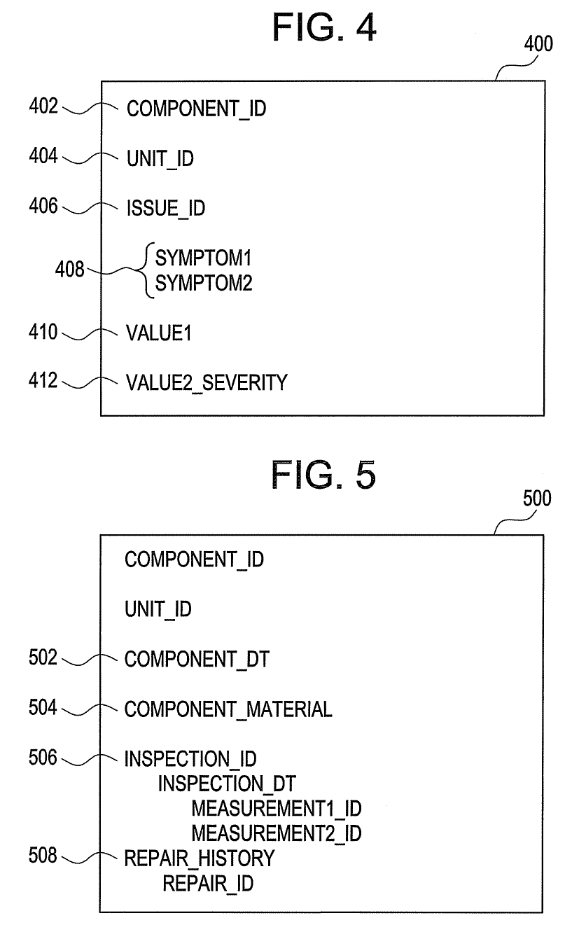

Fleet-wide history database 120 stores a summary of information for a fleet of assets and their individual components. This information may include inspection and repair histories. The information is aggregated by asset class, which reflect assets that share similar characteristics. For example, the summary may specify a normalized risk value that allows comparison among components within an asset, as well as comparison among two or more assets. In exemplary embodiments, the fleet-wide history database 120 stores a record for each component class in a given fleet of assets. A sample record utilized by the maintenance evaluation services for storing this information is shown and described in FIG. 4.

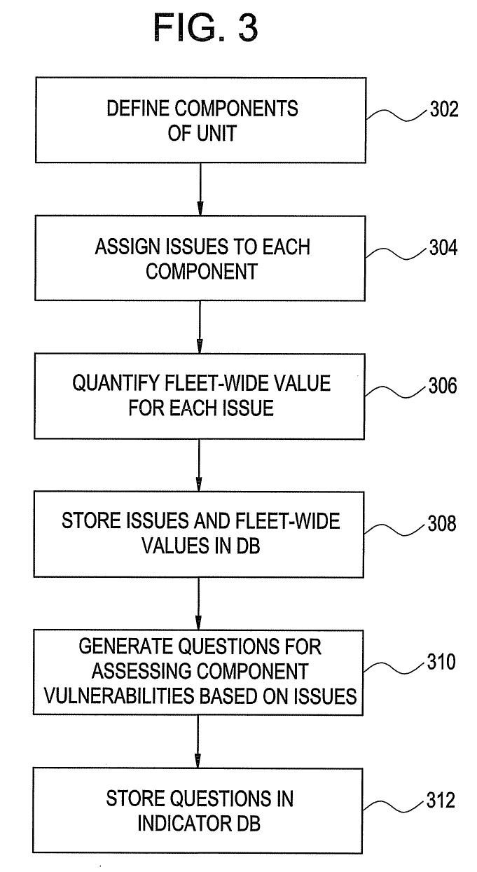

Fleet-wide component database 122 stores a pre-defined set of the components of a given asset, along with a set of pre-defined issues, or factors (e.g., risk factors), associated with each of the components. A fleet-wide value (e.g., a fleet-wide risk value) is calculated and assigned to each component. The fleet-wide value of the component reflects a quantified measure of risk associated with a particular component class based upon past experiences (e.g., inspection and repair histories). By breaking down the issues and corresponding risk values by component, the maintenance evaluation services enables risk assessments to be performed at a lower level of detail for an asset. A process for calculating fleet-wide values for component classes is described in FIG. 3. In exemplary embodiments, these fleet-wide values may be captured in a database record, along with fleet-wide issues, as shown in the sample record 400 of FIG. 4.

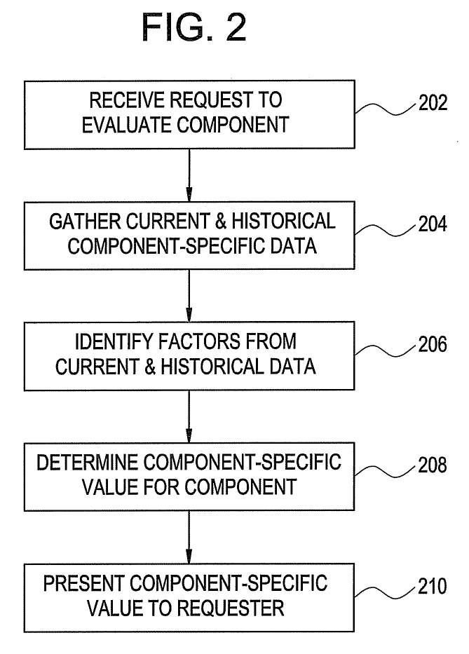

Turning now to FIG. 2, a process for implementing the maintenance evaluation activities in exemplary embodiments will now be described. For purposes of illustration, it is assumed that a particular component is presenting a symptom that has prompted a request for evaluation as part of a pre-emptive measure. It will be understood, however, that the maintenance evaluation services may be initiated even where no symptoms are present in order to evaluate the overall health of an asset.

At step 202, the maintenance evaluation application 108 receives a request from one of client systems 104 (e.g., via a requester) to evaluate a component. The maintenance evaluation application 108 includes a user interface 110 that guides a requester through the request process. The user interface 110 prompts the requester to enter identifying information about the component, e.g., a component identifier.

At step 204, the maintenance evaluation component gathers current and historical component-specific information. Current information is acquired from the client system 104 and refers to results of direct observations relating to the performance of the component. These results may be measurements reflecting speed, temperature, pressure, time, or other elements that are used in ascertaining the health of a component. These observations are generally provided by an operator of the asset that utilizes the component. In exemplary embodiments, the current information is acquired by presenting standardized questions to the client system 104 which are targeted at the particular component identified by the client system 104 in step 202.

In exemplary embodiments, historical component-specific data is acquired from unit history database 118. It will be appreciated, however, that historical component-specific data may be obtained from a variety of different sources. The historical component-specific data may be provided in a component history record particular to the component, a sample of which is shown in FIG. 5. A record 500 corresponding to the particular component is retrieved via the COMPONENT_ID field and/or the UNIT_ID field. As shown in the component history record 500, fields of information such as the component's age (COMPONENT_DT 502) and the composition of the component (COMPONENT_MATERIAL 504) provide the maintenance evaluation services with information specific to the particular component under evaluation. The component's age and composition may be applied during the risk assessment in factoring the overall risk of the component. Other historical component-specific data include inspection results provided in INSPECTION_ID field 506. For example, if the asset under evaluation has not undergone inspection in a minimum specified period of time, this would be a risk factor that is reflected in the assessment (e.g., cause the risk value of the component to go up). The same is true for the repair history of the component, which is implemented via REPAIR_HISTORY field 508. For example, if the component has failed a number of times in the past, this would impact the calculation of the risk value for the component.

At step 206, the maintenance evaluation application 108 evaluates the current and historical component-specific data and identifies factors for the component. Based upon the responses to the questions and the historical information provided in record 500, the maintenance evaluation application 108 identifies risk factors, e.g., component age, composition, inspection interval, repair, symptoms presented by the client system 104 in response to the questions, etc. With respect to the inspection interval, the maintenance evaluation application 108 may assess risk based upon the duration of time that elapses between inspections (e.g., the longer a unit goes without being inspected, its risk increases).

At step 208, a component-specific value (e.g., component-specific risk value) is calculated by applying the factors (e.g., risk factors) to a fleet-wide value (e.g., fleet-wide risk value) assigned to a component class to which the component belongs. This fleet-wide value for the component is retrieved from fleet-wide component history record 400 of FIG. 4 in fleet-wide component database 122. As indicated above, the fleet-wide risk value reflects a quantified measure of risk associated with a particular component class based upon past experiences (e.g., inspection and repair histories of like components over time) via one or more of fields 406 and 408. In exemplary embodiments, fleet-wide component values (e.g., fleet-wide component risk values) are calculated utilizing the process described in FIG. 3 and are used in VALUE1 field 410 and VALUE2_SEVERITY field 412.

The component-specific value may be calculated via an algorithm that applies weights to various symptoms and factors of the individual component and modifies or adjusts the fleet-wide component value to reflect these individual symptoms and factors.

At step 210, the component-specific value is presented to the client system 104. In addition, the maintenance evaluation application 108 may also recommend a course of action based upon the component-specific value, such as an inspection or repair action.

Turning now to FIG. 3, a process for determining fleet-wide component values in exemplary embodiments will now be described. At step 302, components of a unit are defined. Using the power generator example above, components may include a stator, cylinder head, gas valves, water pump, etc. Likewise, each component may also be defined as an asset whereby its subcomponents are reflected as components of the asset. For example, a stator may be defined as an asset with components including retaining rings, core laminations, stator windings, field surface, wedges, coil end turns, etc.

At step 304, factors (e.g., risk factors), or issues, are assigned to each of the components. Factors may include component age, usage, composition, inspection results, inspection interval, repair histories, etc. The severity of risk or effect may also be utilized.

At step 306, a fleet-wide value (e.g., fleet-wide risk value) is calculated for each factor (e.g., risk factor). The fleet-wide value applies historical information for each component to algorithmic process that factors in the performance data acquired for each component over a period of time. The fleet-wide value also considers the severity of risk in the analysis, e.g., the consequences of incurring the risk.

At step 308, the factors (e.g., risk factors) and corresponding fleet-wide values (e.g., fleet-wide risk values) are stored in fleet-wide component database 122. These fleet-wide values for each component are aggregated at the asset level and a fleet-wide value (e.g., fleet-wide risk value) for each asset is calculated. The fleet-wide value for assets are stored in fleet-wide history database 120.

At step 310, questions are generated for assessing component vulnerabilities based upon the factors (e.g., risk factors). As indicated above, the questions may be developed by an engineer or subject matter expert of the asset. The questions are directed to targeting specific symptoms known to affect the safe and efficient operation of the asset. The questions may solicit information, such as operating measurements or usage information (e.g., how the particular asset is used). The questions may also solicit ambient conditions around the asset (e.g., ambient temperatures). The questions may reflect operating conditions that address conditions that are regulated by a government or by an industry standard.

The questions are stored in indicator database 116 at step 312. The questions are retrieved by the maintenance evaluation application 108 based upon the particular asset or component under evaluation as described in FIG. 2.

As described above, the exemplary embodiments can be in the form of computer-implemented processes and apparatuses for practicing those processes. The exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the exemplary embodiments. The exemplary embodiments can also be in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the exemplary embodiments. When implemented on a general-purpose microprocessor, the computer program code segments configure the microprocessor to create specific logic circuits. The technical effect of the computer program code is to evaluate and calculate the reliability of assets and their individual components.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A method for determining asset reliability, comprising:
receiving a request to evaluate a component from a requester, the component comprising at least a portion of the asset that is operated by the requester;
acquiring at least one of current and historical component-specific data for the component;
identifying factors from the current and historical component-specific data, the factors reflecting events, the occurrence of which are known to have an effect on asset health;
determining a component-specific value for the component by applying the factors to a fleet-wide value assigned to a component class to which the component belongs; and
presenting the component-specific value to the requester, the component-specific value indicative of a potential event with respect to the component.

2. The method of claim 1, wherein the historical component-specific data includes results of past inspections and repair histories.

3. The method of claim 1, wherein the historical component-specific data includes at least one of:
component age;
component usage; and
component composition.

4. The method of claim 1, further comprising:
defining components of the asset and assigning the factors to each of the components using fleet-wide inspection and repair history information;
quantifying the fleet-wide value for each of the factors based upon at least one of a likelihood of occurrence and measure of risk;
storing the factors and corresponding fleet-wide values in a fleet-wide component database;
generating questions for assessing potential vulnerabilities of the components based upon the factors, the questions addressing symptoms with causal connections to the factors; and
storing the questions in an indicator database.

5. The method of claim 4, wherein the acquiring current component-specific data includes:
retrieving at least one question directed to the component from the indicator database in response to the request;
presenting the at least one question to the requester; and
receiving a response that includes current observations and component-specific performance measurements.

6. The method of claim 4, further comprising:
updating the fleet-wide component database to reflect the component-specific value.

7. The method of claim 1, further comprising:
determining a recommended course of action based upon the component-specific value and presenting the recommended course of action to the requester, the recommended course of action including at least one of:
inspection of at least one of the component and asset; and
repair of at least one of the component and asset.

8. The method of claim 1, further comprising:
determining an asset-specific value for the asset by comparing an aggregate value of the component-specific values determined for a plurality of components of the asset to a fleet-wide value assigned to an asset class to which the asset belongs; and
presenting the asset-specific value to the requester.

9. The method of claim 8, further comprising:
presenting at least one of the component-specific values and the asset-specific value to the requester in graphical form.

10. The method of claim 1, wherein the asset comprises an electro-mechanical device.

11. A system for determining asset reliability, comprising:
a computer processing device;
a unit history database in communication with the computer processing device;
a fleet-wide component database in communication with the computer processing device; and
a maintenance evaluation application executing on the computer processing device, the maintenance evaluation application performing:
receiving a request to evaluate a component from a requester, the component comprising at least a portion of the asset that is operated by the requester;
acquiring at least one of current component-specific data for the component from the requester;
acquiring historical component-specific data for the component from the unit history database;
identifying factors from the current and historical component-specific data, the factors reflecting events, the occurrence of which are known to have an effect on asset health;
determining a component-specific value for the component by applying the factors to a fleet-wide value assigned to a component class to which the component belongs, the fleet-wide value retrieved from the fleet-wide component database; and
presenting the component-specific value to the requester, the component-specific value indicative of a potential event with respect to the component.

12. The system of claim 11, wherein the historical component-specific data includes results of past inspections and repair histories.

13. The system of claim 11, wherein the historical component-specific data includes at least one of:
component age;
component usage; and
component composition.

14. The system of claim 11, further comprising an indicator database in communication with the computer processing device; wherein the maintenance evaluation application further performs:
defining components of the asset and assigning the factors to each of the components using fleet-wide inspection and repair history information;
quantifying the fleet-wide value for each of the factors based upon at least one of a likelihood of occurrence and measure of risk;
storing the factors and corresponding fleet-wide values in the fleet-wide component database;
generating questions for assessing potential vulnerabilities of the components based upon the factors, the questions addressing symptoms with causal connections to the factors; and
storing the questions in the indicator database.

15. The system of claim 14, wherein the acquiring current component-specific data includes:
retrieving at least one question directed to the component from the indicator database in response to the request;
presenting the at least one question to the requester; and
receiving a response that includes current observations and component-specific performance measurements.

16. The system of claim 14, wherein the maintenance evaluation application further performs:
updating the fleet-wide component database to reflect the component-specific value.

17. The system of claim 11, wherein the maintenance evaluation application further performs:
determining a recommended course of action based upon the component-specific value and presenting the recommended course of action to the requester, the recommended course of action including at least one of:
inspection of at least one of the component and asset; and
repair of at least one of the component and asset.

18. The system of claim 11, further comprising a fleet-wide history database in communication with the computer processing device, wherein the maintenance evaluation application further performs:
determining an asset-specific value for the asset by comparing an aggregate value of the component-specific values determined for a plurality of components of the asset to a fleet-wide value assigned to an asset class to which the asset belongs, the fleet-wide value assigned to the asset received from the fleet-wide history database; and
presenting the asset-specific value to the requester.

19. The system of claim 8, wherein the maintenance evaluation application further performs:
presenting at least one of the component-specific values and the asset-specific value to the requester in graphical form.

20. The system of claim 11, wherein the asset comprises an electro-mechanical device.
